(19) United States
(12) Patent Application Publication
(10) Pub. No.: US 2017/0200181 A1
(43) Pub. Date: Jul. 13, 2017

(54) METHOD OF PROVIDING SALES-BASED DISCOUNT

(71) Applicant: Chan Go KANG, Seoul (KR)

(72) Inventor: Chan Go KANG, Seoul (KR)

(21) Appl. No.: 15/082,552

(22) Filed: Mar. 28, 2016

(30) Foreign Application Priority Data
Jan. 12, 2016 (KR) 10-2016-0003693

(51) Int. Cl. G06Q 30/02

(52) U.S. Cl. CPC G06Q 30/0223; G06Q 30/0222; G06Q 30/0235

(57) ABSTRACT

A method of providing a discount on a product based on sales includes paying, by a purchaser, a price for a product selected by the purchaser, upon the purchaser paying the price, calculating, by a processor, a discount amount or a discount rate based on sales during a predetermined period, and calculating, by the processor, a discounted price for the product based on the discount amount or the discount rate.

### CROSS-REFERENCE TO RELATED APPLICATIONS

This application is based upon and claims the benefit of priority from Korean Patent Application No. 10-2016-0003693, filed Jan. 12, 2016, the entire contents of which are incorporated herein by reference.

### BACKGROUND

1. Field

The present disclosure relates to a method of providing a discount to a purchaser in an electronic commerce (e-commerce), and more particularly, to a method of providing a discount to a purchaser based on sales at the time of payment.

2. Description of the Related Art

In recent years, an e-commerce, which is a form of trading a product by using the Internet, has been widely used with development of the Internet and the communication technology. In the e-commerce, a shopping mall website is provided on the Internet and products are usually sold through advertisement or sales strategy for intensifying purchase needs of purchasers who make an access to the website. In particular, as the sales strategy for increasing the purchase needs of the purchasers, a discount is provided to the purchasers in various ways.

The method of sale with discount includes application of a fixed discount rate for each product or application of a discount rate for a specific period. However, the method of applying the fixed discount rate may discourage potential customers as the product can be considered to have lower quality than a product of the regular price because the discount is offered without a specific rule. The method of applying a discount for a predetermined period gives a burden of advertisement cost to a seller because an intensive advertisement is needed in advance. Korean Pat. Pub. No. 10-2005-0101115 describes such a conventional method of providing a discount to potential customers.

Further, with the method of providing a discount to many and unspecified customers, a seller can hardly expect an easy sales forecast and a customer can hardly recognize a benefit that is given to anyone as a substantial benefit.

### SUMMARY

According to some embodiments of the present invention, a method of providing a discount on a product based on sales includes paying, by a purchaser, a price for a product selected by the purchaser, first calculating including, upon the purchaser paying the price, calculating, by a processor, a discount amount or a discount rate based on sales during a predetermined period, and second calculating including calculating, by the processor, a discounted price for the product based on the discount amount or the discount rate.

The above and other objects, features, advantages and technical and industrial significance of this invention will be better understood by reading the following detailed description of exemplary embodiments of the invention, when considered in connection with the accompanying drawings. Therefore, the accompanying drawings merely instantiate the exemplary embodiments of the present invention, and the present invention should not be construed as being limited to the contents of the drawings.

### BRIEF DESCRIPTION OF THE DRAWINGS

FIG. 1 is a flowchart of a conventional method of paying a price for a product by using a discount coupon provided by a seller in an e-commerce;

FIG. 2 is a flowchart of a method of providing a discount to a purchaser according to some embodiments of the present invention; and

FIG. 3 is a schematic diagram for illustrating reference sales according to some embodiments of the present invention.

### DETAILED DESCRIPTION OF THE PREFERRED EMBODIMENTS

Exemplary embodiments of the present disclosure are described in detail below with reference to the accompanying drawings. In the following descriptions, like reference numerals designate like elements although the elements are shown in different drawings. Further, detailed descriptions of known functions and configurations incorporated herein are omitted for the purpose of clarity and for brevity.

it is an object of the present invention to provide a method of providing a discount, which is capable of expediting sales by arousing customer interests.

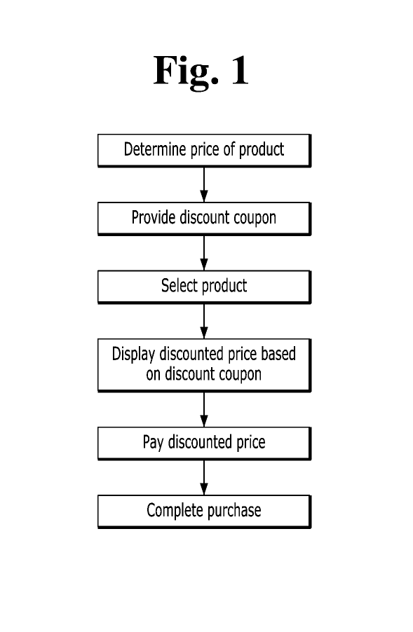

FIG. 1 is a flowchart of a conventional method of paying a price for a product by using a discount coupon provided by a seller in an e-commerce

As shown in FIG. 1, in a conventional e-commerce, a seller advertises his or her product or service (hereinafter, collectively “product”) by issuing a discount coupon indicating a discount amount or a discount rate, thus intensifying customer interest. However, in the psychological position of a customer, the original price of the product is not recognized as the price of the product, instead the discounted price by the discount coupon tends to be the substantial price of the product. Further, in the position of a seller, the discount coupon can hardly intensify the customer interest, i.e., the discount coupon can hardly carry out an aggressive marketing, because the discount coupon is issued by calculating the discount amount or the discount rate that is enough to produce a profit from the management aspect.

The inventor of the present invention has noticed that a method of providing a discount on a product after the payment for the product enables a substantial benefit to be provided to a purchaser who purchased the actual product instead of many and unspecified customer. Further, instead of providing a discount benefit based on a predetermined discount amount or discount rate, a method of calculating the discount amount or the discount rate is distinguished from the conventional technology, which allows various discount benefits (e.g., take 10% of take 100%) to be expected depending on the time of payment.

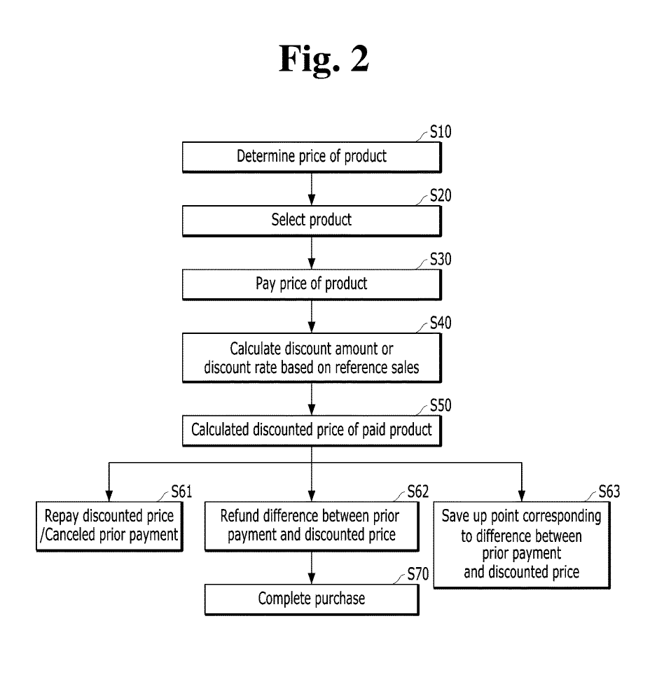

FIG. 2 is a flowchart of a method of providing a discount o a purchaser according to some embodiments of the present invention

At Step S10, a seller determines a price of a product, and displays the price to enable a customer (prospective purchaser) to confirm the price. In this case, information on detailed description of the product and information that a discount according to some embodiments of the present invention will be provided after payment are displayed together on the product. At Step S20, the customer (prospective purchaser) confirms the price of the product set by the seller, and selects a desired product. At Step S30, the customer (prospective purchaser) makes a payment for the product with the price determined by the seller at Step S10.

At Step S40, a discount amount or a discount rate is calculated based on sales (hereinafter, “reference sales”) for a predetermined period.

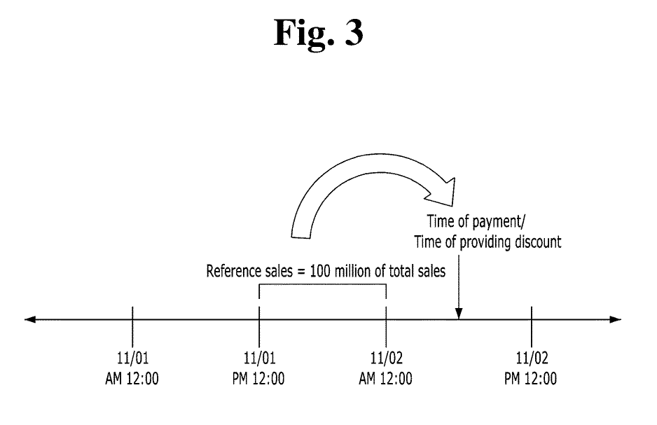

In some embodiments, the reference sales is a sales amount in a sales interval previous to a sale interval to which the time of performing Step S30 belongs among a plurality of sale intervals divided by the predetermined period. The reference sales is described in detail with reference to FIG. 3.

In FIG. 3, the horizontal axis represents time, which is divided by 12-hour interval. The intervals are arbitrarily divided to differentiate the reference sales. The length of the interval can be set in various ways. In the example shown in FIG. 3, the time interval is 12 hours. Further, total sales from 11/01 PM12:00 to 11/02 AM12:00 is assumed to be 100,000,000 KRW. In this case, 100,000,000 KRW is the reference sales. The seller determines a discount amount or a discount rate to be provided to a purchaser who purchases a product in the next interval from 11/02 AM12:00 to 11/02 PM12:00 based on the reference sales. The reference sales can be automatically calculated by a computer or the like by using a table in which the discount amount or the discount rate is stored in advance in association with the reference sales. That is, the seller can select the discount amount or the discount rate in proportion to the sales, and hence more discount benefit can be provided to the customers than in the application of a discount to many and unspecified customers. Moreover, the seller can select the discount amount or the discount rate according to the sales, and hence the burden of sales decrease due to the discount is within an expected range. Although the interval to which the reference sales belongs is described to be immediately prior to the time of payment in FIG. 3, it can be set to various sales intervals considering a substantial time or the like required to calculate the sales, such as a day before, two weeks before, a month before, and the like.

In some embodiments, the seller or a computer that determines how to provide the discount determines the sales intervals based on sales cycle of a product same as the one to be purchased by a customer or one or more products that belong to the same product group (e.g., a time interval of ordering a product by the seller).

In some embodiments, the seller or a computer that determines how to provide the discount determines lengths of the sales intervals based on a range of fluctuation in the sales. For example, when the range of fluctuation in the sales is large, it is possible to prevent the discount ratio from being changed to a large extent by taking a long sales interval and averaging the sales in the sales interval. Further, an interval between peaks in the range of fluctuation in the sales can be determined as the lengths of the sales intervals. In this manner, the sales intervals can be switched depending on the change of the sales.

In some embodiments, the reference sales is a sales amount for the same product as the purchased product in the sales interval previous to the sale interval to which the time of payment belongs. The same product means a product with the same brand, the same shape, and the same name.

In some embodiments, the reference sales is a sales amount for a product of the same product group as a product group to which the purchased product belongs in the sales interval previous to the sale interval to which the time of payment belongs. The same product group means products that belong to the same category among a plurality of categories for classifying products. For example, shirts, pants, and the like are products of a product group “apparels”.

In some embodiments, the reference sales is a sales amount of the same seller who sold the purchased product in the sales interval previous to the sale interval to which the time of payment belongs. In the case of open market system, a plurality of sellers sells products, and hence the discount is provided to a purchaser who purchases a product from the same seller considering the sales of the same seller.

Thereafter, at Step S50, a discounted price of the product for which the payment has been made at Step S30 is calculated based on the discount amount or the discount rate determined at Step S40.

As described above, the method of providing a discount based sales according to some embodiments of the present invention is capable of intensifying the customer interest by enabling customers to expect various discount benefits depending on the time of payment instead of a discount benefit based on a preset discount amount or discount rate. To this end, different discount amounts or discount rates are calculated for different customers at Step S40. For example, the discount rate is set to 10% at minimum, but in some cases, the discount rate is calculated as 100%. In this case, the number of providing the discount rate of 100% can be set in various ways by the seller based on the reference sales. That is, a benefit of purchasing a product at no cost is provided to a purchaser, for advertisement and for intensifying the customer interest.

In some embodiments, the discount amount or the discount rate is calculated further based on a payment method used at Step S30. The representative payment method includes cash or credit card. When the purchaser uses a credit card, a predetermined fee may have to be paid to a credit card company. Therefore, the discount amount or the discount rate is set to give more benefit to a purchaser who pays by cash.

In some embodiments, when the payment method is by cash, a discount amount equal to or larger than a predetermined minimum discount amount or a discount rate equal to or larger than a predetermined minimum discount rate. In other words, an additional discount amount or discount rate is calculated in a state in which the minimum discount amount or the minimum discount rate is guaranteed instead of zero or 0%.

In some embodiments, when the payment method is by credit card, a discount amount equal to or larger than a predetermined minimum discount amount set by a credit card company or a discount rate equal to or larger than a predetermined discount rate set by the credit card company. The fee agreement can be made appropriately depending on the credit card company. Therefore, the minimum discount amount or the minimum discount rate can be set in various ways depending on the contents of the agreement. The additional discount amount or discount rate is then calculated in a state in which the minimum discount amount or the minimum discount rate is guaranteed.

In some embodiments, the discount amount is zero or the discount rate is 0%. In this case, a free gift can be provided to the purchaser. The free gift can be a product such as a sample product for advertising a company. In this manner, the method of providing the discount benefit to the purchaser includes various ways.

In some embodiments, the benefit is provided to the purchaser by a repaying the discounted price and canceling the paid amount at Step S30 (Step S61).

In some embodiments, the benefit is provided to the purchaser by refunding an amount corresponding to a difference between the discounted price and the paid price at Step S30 (e.g., a discount in charging a credit card, money transfer, and the like) (Step S62).

In some embodiments, the benefit is provided to the purchaser by saving up a point corresponding to the difference between the discounted price and the paid price at Step S30 (Step S63).

In some embodiments, in order to intensify the customer interest, a total discount amount and a realtime remaining discount amount are displayed to the customers. For example, when the reference sales 100,000,000 KRW and an amount that can be provided as the discount benefit is set to 10,000,000 KRW, the total discount amount of 10,000,000 KRW is displayed (opened), which can be provided to purchasers in the sales interval to which the time of performing Step S30 belongs. The remaining total discount amount is also displayed (opened) in realtime. The customers can check the total discount amount and the remaining discount amount, and then make up their mind to purchase the product and make payments before the total discount amount is all used up.

On the other hand, when the total discount amount is almost used up, the available discount amount may be smaller than a payment amount for some product. For example, when the remaining discount amount is 100,000 KRW but a price of a product purchased by a purchaser is 200,000 KRW, the purchaser cannot be provided with a discount over 100,000 KRW or 50%. In this case, the discount amount or the discount rate can be calculated by setting an upper limit of the discount amount or the discount rate to the realtime remaining discount amount available in the sales period to which the time of performing Step S30 belongs or the price paid at Step S30, whichever is smaller.

The method of providing a discount based on sales according to some embodiments of the present invention can be implemented in various forms.

The method of providing a discount based sales according to some embodiments of the present invention can be implemented in a server that is connected to a communication network (Internet). In this case, a purchaser or a seller accesses the server via an information communication terminal connected to the communication network to provide or to be provided with the discount by the method of providing a discount based sales. The information communication terminal includes a mobile phone, a smartphone, a laptop computer, a digital broadcasting terminal, a PDA (personal digital assistants), a PMP (portable multimedia player), a navigation, a slate PC(Personal Computer), a tablet PC, an ultrabook PC, and a wearable device such as a smartwatch, a smart glass), and an HMD (head mounted display).

The method of providing a discount based sales according to some embodiments of the present invention can be applied to a purchaser at an offline store employing a POS (Point Of Sale) terminal. The POS terminal is a known system that supports to provide sales analysis, trend understanding, and management analysis by immediately collecting and storing sales information for each item in a computer and processing the information by the computer in association with information on order, purchase, delivery, stock, and the like. In this case, the above-mentioned purchaser is the POS terminal. In other words, although the actual purchaser is a customer who makes the payment by case or by credit card, in a position of a server to which the POS terminal is connected via a communication network, the POS terminal is recognized as the above-mentioned purchaser and the discount is provided to the POS terminal by the method of providing a discount based sales according to some embodiments of the present invention. A POS manager (store manager) of the offline store can provide a service of repayment or the like depending on the discounted price to the actual purchaser.

In order to execute the above-mentioned control logic, the method of providing a discount based on sales according to some embodiments of the present invention can be executed in a system including a process, an ASIC (application-specific integrated circuit), an additional chipset, a logical circuit, a register, a communication modem, and a data processing unit. Further, when the above-mentioned method of providing a discount based sales is implemented as software, a set of program modules according to the method of providing a discount based sales can be implemented. In this case, the program modules are stored in a memory device and executed by a processor. The memory device can be installed inside or outside the processor, and can be connected to the processor via various known methods. The memory device is a mass storage medium such as a known semiconductor device or hard disk in which data can be recorded and deleted, such as a RAM, a ROM, and an EEPROM, and collectively refers to a device in which data can be stored regardless of a type of the device instead of referring to a specific memory device.

According to some embodiments of the present invention, the discount benefit is provided to a purchaser who purchased the actual product instead of many and unspecified customers. Hence, sellers can provide more benefit to purchasers than in the application of a discount to many and unspecified customers, and the desire of consumption of the customers can be intensified expecting more benefit than the benefit of a typical discount.

According to some embodiments of the present invention, a seller can calculate the discount amount or the discount rate based on the sales, and hence, in the management aspect, a burden on a decrease of sales can be alleviated.

According to some embodiments of the present invention, different discount amounts or discount rates are provided to different purchasers, and hence the desire of consumption of the customers can be intensified or a repurchase rage can be increased by having the customers expect more benefit than the benefit of a typical discount.

Although exemplary embodiments of the present invention have been described for illustrative purposes, those skilled in the art will appreciate that various modifications, additions and substitutions are possible, without departing from the idea and scope of the claimed invention. Accordingly, one of ordinary skill would understand the scope of the claimed invention is not to be limited by the explicitly described above embodiments but by the claims and equivalents thereof.

What is claimed is:

1. A method of providing a discount on a product based on sales, the method comprising:
paying, by a purchaser, a price for a product selected by the purchaser;
first calculating including, upon the purchaser paying the price, calculating, by a processor, a discount amount or a discount rate based on sales during a predetermined period; and
second calculating including calculating, by the processor, a discounted price for the product based on the discount amount or the discount rate.

2. The method according to claim 1, wherein the predetermined period is a first sales period prior to a second sales period in which the paying is performed among a plurality of sales periods divided by the predetermined period.

3. The method according to claim 2, wherein the first sales period is immediately prior to the second sales period.

4. The method according to claim 2, wherein the sales includes sales of same product as the product that is paid at the paying, in the second sales period.

5. The method according to claim 2, wherein the sales includes sales of a product that belongs to a product group to which the product that is paid at the paying belongs, in the second sales period.

6. The method according to claim 2, wherein the sales includes sales of a seller of the product that is paid at the paying, in the second sales period.

7. The method according to claim 1, wherein the first calculating includes calculating different discount amounts or discount rates for different purchasers.

8. The method according to claim 1, wherein the first calculating includes calculating the discount amount or the discount rate further based on a payment method used at the paying.

9. The method according to claim 8, wherein, when the payment method is by cash, the first calculating includes calculating the discount amount or the discount rate to be equal to or larger than a predetermined minimum discount amount or a predetermined minimum discount rate.

10. The method according to claim 8, wherein, when the payment method is by credit card, the first calculating includes calculating the discount amount or the discount rate to be equal to or larger than a predetermined minimum discount amount or a predetermined minimum discount rate set depending on a credit card company.

11. The method according to claim 1, further comprising:
repaying the discounted price; and
canceling a payment paid at the paying.

12. The method according to claim 1, further comprising refunding a difference between the discounted price and the price paid at the paying to the purchaser.

13. The method according to claim 1, further comprising saving up a point corresponding to a difference between the discounted price and the price paid at the paying to the purchaser.

14. The method according to claim 1, further comprising displaying a total discount amount to be provided to purchasers in a sales period in which the paying is performed and a realtime remaining discount amount available in the sales period.

15. The method according to claim 14, wherein the first calculating includes setting an upper limit of the discount amount or the discount rate to the realtime remaining discount amount available in the sales period or the price paid at the paying, whichever is smaller.
